(19) United States
(12) Patent Application Publication
(10) Pub. No.: US 2005/0214707 A1
(43) Pub. Date: Sep. 29, 2005

(54) Dental bracketing system and method

(76) Inventor: Kambiz Kohani, Carlsbad, CA (US)

Correspondence Address: NYDEGGER & ASSOCIATES, 348 OLIVE STREET, SAN DIEGO, CA, 92103, US

(21) Appl. No.: 11/079,897

(22) Filed: Mar. 14, 2005

Related U.S. Application Data
(60) Provisional application No. 60/556,992, filed on Mar. 25, 2004.

(51) Int. Cl. A61C 3/00

(52) U.S. Cl. 433/3

(57) ABSTRACT

A device and method for affixing orthodontic brackets to teeth includes a support member, a holder mounted on the support member for holding orthodontic brackets, and a base member mounted on the support member at a predetermined distance from the holder and parallel to the holder. In operation, a bracket is engaged with the holder and a dental adhesive is applied to the bracket. The base member initially contacts the tooth, followed by the bracket, which urges against the surface of the tooth at the predetermined distance from the base member. Once positioned, the bracket is held in place until the adhesive sets, thereby affixing the bracket to the tooth.

This application claims the benefit of U.S. Provisional Patent Application Ser. No. 60/556,992, filed Mar. 25, 2004.

### FIELD OF THE INVENTION

The present invention generally pertains to devices and methods for use in orthodontics. More particularly, the present invention pertains to devices and methods for positioning and affixing orthodontic brackets onto teeth. The present invention is particularly, but not exclusively useful as a device, and a method for using the device, wherein the device has a specific dimensional configuration for positioning and affixing orthodontic brackets at predetermined locations on the surface of teeth for the precision alignment of a plurality of brackets.

### BACKGROUND OF THE INVENTION

Orthodontics is a branch of dentistry that deals with the treatment or correction of irregularities in teeth. In general, orthodontics involves realigning, or straightening, the teeth relative to each other. Perhaps the most common, and most well known method by which irregularities in teeth are corrected is through the use of braces. To be effective, however, braces need to be installed with precision. In a typical procedure for installing braces, brackets are first mounted onto the teeth that are to be straightened. Bands are then placed around the molars at the back of the mouth. Archwires can then be threaded through the brackets and anchored to the bands. The archwires then gently force the teeth into a desired alignment over a period of time. In this process, a proper alignment of the orthodontic brackets is essential. Indeed, it is the alignment of the brackets, and the shape of the archwire that are the primary means by which forces are applied to realign the teeth, and to establish how much movement of the teeth is required for this purpose.

Heretofore, when braces have been used to realign teeth, it has been necessary for an orthodontist to mount the brackets onto the surface of each tooth by hand. In detail, this has required applying an adhesive to the bracket, and then manually positioning the bracket at the desired location on the tooth. It was then necessary to hold the bracket steady, in place, until the adhesive was set. A concern in this procedure is that any movement of the hand, or an early removal of support on the bracket prior to adequate curing of the adhesive, could possibly cause the bracket to shift from its desired position on the tooth.

It can be problematic that the light curable adhesives which are typically used to secure an orthodontic bracket to a tooth have very short cure times. On the one hand, it reduces the time for securing the bracket. On the other hand, it makes it all the more critical that each bracket is precisely positioned at the desired location prior to curing the adhesive. Not surprisingly, it is a difficult task to consistently perform such a task freehand. An undesirable consequence here is that a poorly affixed bracket must be removed and replaced. Leaving misaligned brackets in place is, simply, unacceptable.

In light of the above, it is an object of the present invention to provide a device, and a method for using the device, wherein the device has a specific dimensional configuration for accurately and consistently positioning and affixing an orthodontic bracket at a predetermined location on the surface of a tooth for the precision alignment of the bracket with a plurality of other such brackets. It is another object of the present invention to provide an orthodontic device that decreases the time and cost required for mounting brackets onto teeth. Still another object of the present invention is to provide a system and method for mounting brackets on teeth that is easy to use, relatively simple to implement, and comparatively cost effective.

### SUMMARY OF THE INVENTION

In accordance with the present invention, a device for positioning and affixing an orthodontic bracket to the surface of a tooth includes a support member and a bracket holder which is mounted on the support member. Also included is a base member that is mounted on the support member at a predetermined distance “d” from the bracket holder. Both the bracket holder and the base member respectively define axes, with the axis of the bracket holder being substantially parallel to the axis of the base member.

An orthodontic bracket that is suitable for use with the present invention can be generally described as having a base portion. A first tie-wing and a second tie-wing extend from the base portion, and each of the tie-wings is formed with a transverse slot of a width “t”. Structurally, these transverse slots are aligned with each other to simultaneously receive an archwire. As indicated above, the archwire is then used to impart a force on the bracket, and thereby onto the tooth for the purpose of realigning the tooth. The underside of the orthodontic bracket (i.e. the side that is opposite the tie-wings) is a surface to which a dental adhesive may be applied.

In a particular embodiment of the present invention, the bracket holder is a substantially flat, plate-like structure that has a thickness “t”. The base member can also be a substantially plate-like structure. Alternatively, the base member may be a beam-like structure. In either case, the support member is provided to hold the plane of the bracket holder substantially parallel to the base member. In combination, the support member, the bracket holder, and the base member collectively define a bracket positioning assembly. As intended for the present invention, the bracket positioning assembly is engageable with an elongated handle. Further, a light source for generating a curing light may be mounted on the handle.

Operationally, to begin a bracket placement procedure, an orthodontist determines a distance “d” between a desired position for the orthodontic bracket on the tooth, and the surface of the tooth that is nearest the occlusal plane (i.e. the imaginary surface on which upper and lower teeth meet). This distance is then used to select a bracket positioning assembly that has the corresponding distance “d” between its bracket holder and its base member. As envisioned by the present invention, a number of different bracket positioning assemblies will be available for use by an orthodontist. Specifically, each of the bracket positioning assemblies will have a unique distance “d” between the bracket holder and the base member.

After an appropriate bracket positioning assembly has been selected, it is engaged to the handle. The handle can then be manipulated to engage the bracket positioning assembly with an orthodontic bracket. As contemplated by the present invention, the bracket holder can be engaged with the transverse slots in the tie-wings of the orthodontic bracket to hold the orthodontic bracket on the support member.

Once the orthodontic bracket has been engaged with the bracket holder of the bracket positioning assembly, the orthodontist applies a light sensitive dental adhesive to the surface on the underside of the base portion of the bracket. The orthodontist then positions the base member of the bracket positioning assembly in contact with the tooth. While the base member is in contact with the tooth, the orthodontist urges the bracket against the surface of the tooth at the predetermined distance “d” from the base member. Once positioned, the light source is activated to cure the dental adhesive and thereby affix the bracket to the surface of the tooth. After the bracket is firmly mounted on the tooth, the light source is deactivated. The bracket holder is then disengaged from the bracket and the bracket positioning assembly is removed from the patient's mouth. The bracket positioning assembly can then be disengaged from the handle, if desired. In any event, the procedure mentioned above can be repeated, using different, appropriate bracket positioning assemblies, until all of the teeth to be realigned have been fitted with an orthodontic bracket.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a elevation view of an orthodontic bracket affixing device in accordance with the present invention:

FIG. 2 is a perspective view of the bracket positioning assembly;

FIG. 3 is a perspective view of a typical orthodontic bracket; and

FIG. 4 is an elevation view of the orthodontic bracket affixing device in position to affix an orthodontic bracket to the surface of a tooth.

### DESCRIPTION OF THE PREFERRED EMBODIMENTS

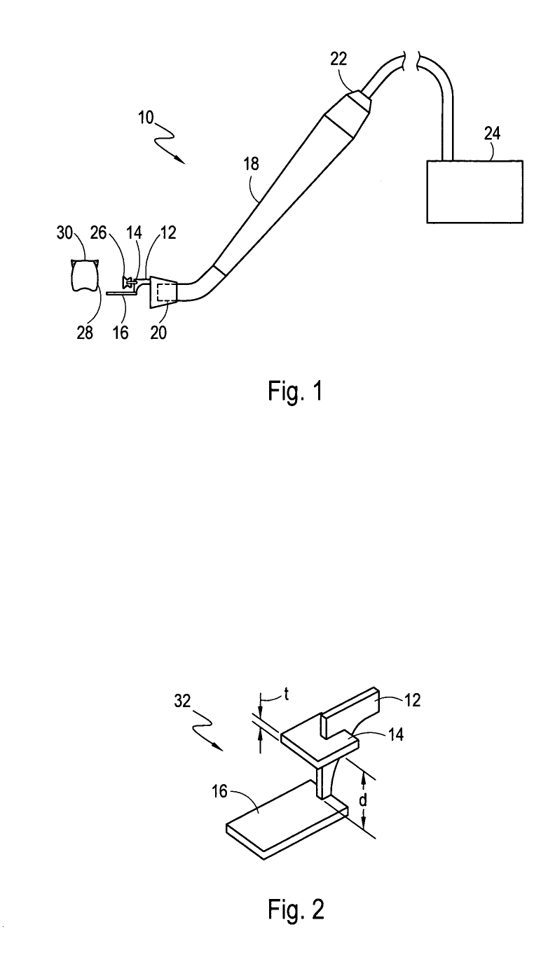

Referring initially to FIG. 1, a device in accordance with the present invention is shown and is generally designated 10. As shown, the device 10 includes a support member 12, a bracket holder 14 mounted on the support member 12, and a base member 16, also mounted on the support member 12. Also shown is an elongated, tubular handle 18 that has a first end 20 and a second end 22. The first end 20 is engageable with the support member 12 to hold the support member 12 on the handle 18. Further, the second end 22 is engageable with a light source 24 for generating a curing light. This structure cooperates to mount an orthodontic bracket 26 (hereinafter bracket 26) to the surface 28 of a tooth 30.

In FIG. 2, the support member 12, the bracket holder 14 and the base member 16 are collectively designated as a bracket positioning assembly 32. It can be seen that the bracket holder 14 is preferably a substantially rectangular, plate-like structure of a thickness “t”. Similarly, the base member 16 is also a substantially rectangular, plate-like structure and is oriented on the support member 12, to be substantially parallel to the bracket holder 14. As shown, the base member 16 is positioned on the support member 12 at a predetermined distance “d” from the bracket holder 14. Importantly, as contemplated by the present invention, a number of bracket positioning assemblies 32 are available to an orthodontist for any given procedure. Moreover, each assembly 32 will have a unique distance “d” between the bracket holder 14 and the base member 16 that is different from other assemblies 32.

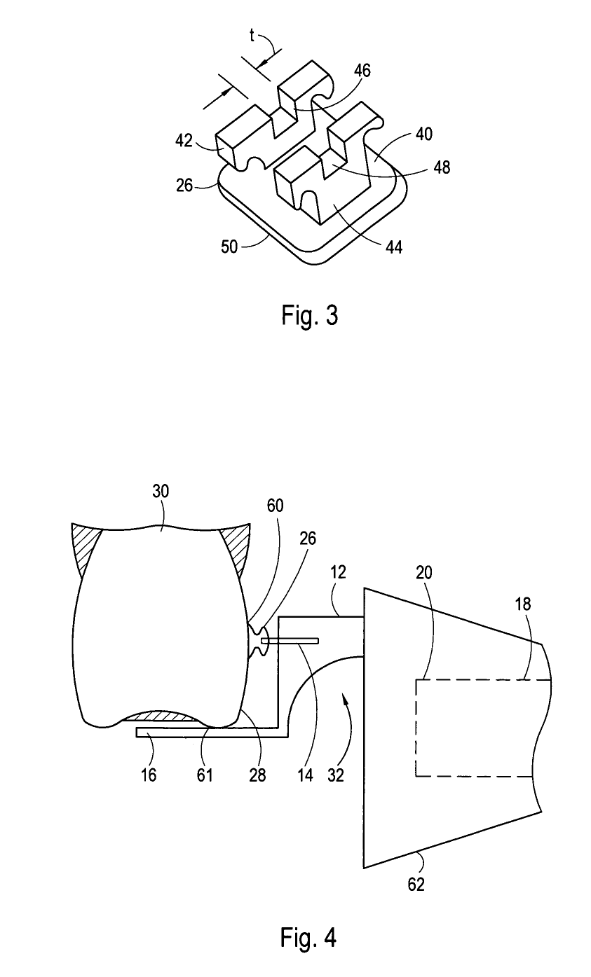

Referring now to FIG. 3, a typical orthodontic bracket 26 that is suitable for use with the presently claimed invention is shown. Structurally, the bracket 26 has a base portion 40 from which extends a first tie-wing 42 and a second tie-wing 44. The first tie-wing 42 is formed with a first transverse slot 46 of a width “t”. Similarly, the second tie-wing 44 is formed with a second transverse slot 48 of a width “t”. As shown, the first transverse slot 46 and the second transverse slot 48 are aligned to respectively receive the bracket holder 14 (see FIG. 2) therein for holding the orthodontic bracket 26 on the support member 12. Further, the base portion 40 is also formed with a surface 50 that is on the bracket 26, opposite the first tie-wing 42 and the second tie-wing 44.

The operation of the device 10 is perhaps best appreciated by referring to FIG. 4. Initially, as mentioned above, the desired location of the bracket 26 on the tooth 30 is determined. The distance “d” from this desired location to the surface 61 of tooth 30 that is nearest the occlusal plane is then measured. An appropriate bracket positioning assembly 32 can then be selected. Specifically, a bracket positioning assembly 32 that has the corresponding distance “d” between its bracket holder 14 and its base member 16 is selected and mounted on the first end 20 of the handle 18. Next, a bracket 26 is placed on the bracket holder 14 by engaging it simultaneously with the first transverse slot 46 and the second transverse slot 48 (see FIG. 3). A light curable dental adhesive 60 (i.e. ultraviolet light curable adhesive) is then applied to the surface 50 (see FIG. 3) of the bracket 26 facing the tooth 30. Next, the base member 16 is moved into contact with the surface 61 of tooth 30 that is nearest the occlusal plane. Once contact between the base member 16 and the surface 61 of tooth 30 has been made, the surface portion 50 of the bracket 26 is urged against the surface 28 of tooth 30 at the predetermined distance “d” from the base member 16 and, hence, from the surface 61 of tooth 30.

After the bracket 26 is positioned on the surface 28 of tooth 30, the light source 24 (see FIG. 1) is activated (i.e. ultraviolet light) and a curing light is emitted from the first end 20 of the handle 18. Optionally, a light-confining hood 62 may be placed on the first end 20 to confine the curing light to the area enclosed by the hood 62. When the light curable adhesive 60 has been cured, and the bracket 26 is firmly mounted onto the surface 28 of tooth 30, the light source 24 is deactivated. The bracket holder 14 is then disengaged from the bracket 26, and the bracket positioning assembly 32 can be removed from the mouth of the patient (not shown), completing the procedure.

While the particular device and method for affixing an orthodontic bracket to the surface of a tooth as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A device for affixing an orthodontic bracket to a surface of a tooth which comprises:
a support member;
a holder mounted on said support member for selectively holding the orthodontic bracket at a predetermined location on said support member; and
a base member mounted on said support member at a predetermined distance “d” from said holder, with said base member positioned to contact the tooth and guide the orthodontic bracket into contact with the surface of the tooth for affixing the orthodontic bracket to the surface of the tooth at the predetermined distance “d” from said base member.

2. A device as recited in claim 1 wherein said holder is a substantially plate-like structure with a first side substantially parallel to a second side and having a thickness “t” therebetween.

3. A device as recited in claim 2 wherein said base member is a substantially plate-like structure, and further wherein said base member is oriented on said support member substantially parallel to said holder.

4. A device as recited in claim 2 wherein said base member is a beam-like structure, defining an axis, and further wherein said base member is oriented on said support member with the axis thereof substantially parallel to said holder.

5. A device as recited in claim 1 wherein the orthodontic bracket comprises:
a base portion;
a first tie-wing extending from said base portion, wherein said first tie-wing has a first transverse slot of a width “t”; and
a second tie-wing extending from said base portion and distanced from said first tie-wing, wherein said second tie-wing has a second transverse slot of the width “t”, with the first transverse slot aligned with the second transverse slot for respectively receiving said holder therein to hold the orthodontic bracket on said support member.

6. A device as recited in claim 5 wherein said base portion of the orthodontic bracket is formed with a surface and wherein said device further comprises:
a light curable dental adhesive; and
a means for applying said light curable dental adhesive to the surface of said base portion to affix the orthodontic bracket to the surface of the tooth.

7. A device as recited in claim 6 further comprising:
a handle having an end; and
a means mounted on the end of said handle for selective engagement with said support member, to hold said support member on said handle.

8. A device as recited in claim 7 further comprising a light source for generating a curing light, with said light source being mounted on said handle and oriented thereon to direct the curing light toward the surface of said base portion of the orthodontic bracket to cure the light curable dental adhesive and affix the orthodontic bracket to the surface of the tooth when the orthodontic bracket is positioned on the tooth.

9. A device as recited in claim 8 wherein said light source generates ultraviolet light, and said light curable dental adhesive is an ultraviolet light curable adhesive.

10. An apparatus for affixing an orthodontic bracket to a surface of a tooth, said apparatus comprising:
a support member;
a holder defining a first axis, said holder being mounted on said support member for holding the orthodontic bracket on said support member in a predetermined orientation relative to the first axis; and
a base member defining a second axis, said base member being mounted on said support member with the second axis at a predetermined distance “d” from the first axis and substantially parallel thereto wherein, with said base member in contact with the tooth, the orthodontic bracket contacts the surface of the tooth to affix the orthodontic bracket thereto at the distance “d” from said base member.

11. An apparatus as recited in claim 10 wherein said holder is a substantially plate-like structure with a first side substantially parallel to a second side and having a thickness “t” therebetween.

12. An apparatus as recited in claim 10 wherein said base member is a plate-like structure.

13. An apparatus as recited in claim 10 wherein said base member is a beam-like structure.

14. An apparatus as recited in claim 11 wherein the orthodontic bracket comprises:
a base portion, wherein said base portion is formed with a surface;
a first tie-wing extending from said base portion, wherein said first tie-wing has a first transverse slot of a width “t”; and
a second tie-wing extending from said base portion and distanced from said first tie-wing, wherein said second tie-wing has a second transverse slot of the width “t”, with the first transverse slot aligned with the second transverse slot for respectively receiving said holder therein to hold the orthodontic bracket on said support member.

15. A apparatus as recited in claim 14 wherein said apparatus further comprises:
a light curable dental adhesive; and
a means for applying said light curable dental adhesive to the surface of said base portion to affix the orthodontic bracket to the surface of the tooth.

16. An apparatus as recited in claim 15 further comprising:
a handle having an end, wherein the end is selectively engageable with said support member to hold said support member on said handle; and
a light source for generating a curing light, with said light source being mounted on said handle and oriented thereon to direct the curing light toward the surface of said base portion of the orthodontic bracket to cure the light curable dental adhesive and affix the orthodontic bracket to the surface of the tooth when the orthodontic bracket is positioned on the tooth.

17. A method for affixing an orthodontic bracket to a surface of a tooth, which comprises the steps of:
providing a device having a support member, a holder mounted on said support member for selectively holding the orthodontic bracket at a predetermined location on said support member, and a base member mounted on said support member at a predetermined distance “d” from said holder, wherein said base member defines an axis, and wherein said holder is a substantially plate-like structure with a first side substantially parallel to a second side and having a thickness “t” therebetween, and further wherein said base member is oriented on said support member with the axis thereof substantially parallel to said holder;
contacting the tooth with said base member;
positioning the orthodontic bracket on the surface of the tooth at a predetermined distance “d” from said base member; and
affixing the orthodontic bracket to the surface of the tooth.

18. A method as recited in claim 17 wherein the orthodontic bracket includes a base portion formed with a surface, a first tie-wing extending from said base portion and a second tie-wing extending from said base portion with said second tie-wing distanced from said first tie-wing, wherein said first tie-wing and said second tie-wing each have a transverse slot of the width “t”, said method further comprising the step of simultaneously inserting said holder into the respective transverse slots of said first tie-wing and said second tie-wing.

19. A method as recited in claim 18 further comprising the step of applying a light curable dental adhesive to the surface of said base portion of the orthodontic bracket.

20. A method as recited in claim 19 further comprising the steps of:
generating a beam of curing light;
directing the beam of curing light toward the surface of said base portion of the orthodontic bracket when the orthodontic bracket is positioned on the tooth to cure said light curable dental adhesive; and
maintaining the position of the orthodontic bracket on the surface of the tooth until the orthodontic bracket is affixed thereto.
